(19) United States
(12) Patent Application Publication
(10) Pub. No.: US 2026/0275956 A1
(43) Pub. Date: Sep. 17, 2026

(54) SELF-ADAPTIVE HYDROPOWER PLANT

(71) Applicants: Kean Loo KEH, Gelugor, Penang (MY); Hai Pu KHOR, Johor Baru, Johor (MY)

(72) Inventors: Kean Loo KEH, Gelugor, Penang (MY); Hai Pu KHOR, Johor Baru, Johor (MY)

(21) Appl. No.: 19/168,082

(22) PCT Filed: Mar. 8, 2024
(86) PCT No.: PCT/MY2024/050022

§ 371 Date: Sep. 23, 2025

(30) Foreign Application Priority Data
Mar. 24, 2023 (MY) PI 2023001581

(51) Int. Cl. F03B 17/00

(52) U.S. Cl. CPC F03B 17/005

(57) ABSTRACT

A self-adaptive hydropower plant (1) that enables a continuously circulating volume of water within a closed loop flow path for generating electricity. The plant comprises a primary reservoir (2) for storing and providing a supply of water, a storage tank (3) elevated above the primary reservoir for receiving water from the primary reservoir, a diaphragm (4) within the tank, the diaphragm defining upper and lower chambers (UC, LC) in the tank and the diaphragm being moveable within the tank, a plurality of secondary reservoirs (6, 10, 12) located at an elevation below the tank but above the primary reservoir, at least one turbine (13) positioned below the secondary reservoirs but above the primary reservoir for generating electricity from water distributed from the secondary reservoirs to the primary reservoir and a system controller (14) for controlling and monitoring the operation and flow path of water from the primary reservoir to the tank and secondary reservoirs. The movement of the diaphragm within the tank facilitates the distribution of water from the tank into the secondary reservoirs. The secondary reservoirs are adapted to facilitate the distribution of water to the turbine and the movement of the diaphragm within the tank is in synchrony with the secondary reservoirs to initiate the replenishment of water in the tank by the primary reservoir. The water in the primary reservoir is selectively distributed to the tank and the secondary reservoirs to reduce water loss.

### FIELD OF INVENTION

The invention relates generally to a hydroelectric power plant.

### BACKGROUND OF THE INVENTION

Hydroelectric power plants are one of the key solutions for the renewable energy sector. It is a clean source of energy but the opportunity to build hydroelectric power plants is not easily available due to the inherent dependency on a suitable geographical location. Implementation of a typical hydroelectric power plant is also costly and involves substantial investment, particularly, in terms of finance, manpower and time. Construction of a hydroelectric power plant usually involves deforestation of vast areas of land and virgin forest to build the hydroelectric dam. This is devastating to the environment.

When the hydroelectric power plant is completed, construction of the electricity distribution network further adds on to the cost borne by consumers.

By comparison, expansion and adaptation of hydroelectric power plants are generally very limited.

Micro hydroelectric power plants have been proposed as a good substitute for large hydroelectric power plants but such micro plants must be located at a suitable location such as a river, stream or small waterfall. Finding a suitable location is crucial for operations of the micro plant as ensuring a consistent water head flow rate is critical for generating electricity. The search for a suitable location for micro plants can be challenging.

As the demand for energy increases, energy mix and especially clean energy is the only solution to ensure energy-security, reduce carbon emission and prevent global warming. The International Energy Agency (IEA) reports that the average renewable energy added to the grid is approximately 300 GW per year, from 2021 to 2026. This forms 10% of the total 3,000 GW renewable energy globally. The International Renewable Energy Agency (IRENA) reported that by end 2021, there will be 3000 GW of renewable energy and the growth rate is 9.1% from 2020 to 2021. Renewable energy contributes to 80% of the energy expansion for world population, per year.

PCT publication no. WO 2013/41826 A disclosed a machine where declining inner atmospheric pressure differences are created by establishing sequential siphon connections between adjacent air-tight pressurized chambers. Fluid in these chambers is moved from one chamber to another with decreasing pressure by utilizing hydraulic pumps, a starting battery and a compressor. The fluid is sprayed on to impulse turbines with wheels to generate torque and this force is transformed into electricity.

U.S. Pat. No. 6,420,794 B1 disclosed a hydropower conversion system for circulation of water between a delivering reservoir and a receiving reservoir through hydro-turbines, pumps and a back-up reservoir. Water in the delivering reservoir is maintained at a constant functioning level by an adjusting valve linked with a valve control mechanism to adjust the opening and closing of passages conducting water flowing from the back-up reservoir into the delivering reservoir. Outlets allow excess water to flow out of the back-up reservoir back down to the receiving reservoir. The hydro-turbines are connected to power machinery.

Chinese patent publication no. 1045290 A disclosed a principle of siphon to siphon off water from a lower location to a higher location wherein water is pressurized for generating electricity while it flows from a higher location to lower location.

The PCT publication WO 2013/41826 A teaches of having a combination of mechanical components such as hydraulic pumps and compressors to facilitate a closed system in a hydropower plant in which water is re-circulated for driving water turbines. Similarly, U.S. Pat. No. 6,420,794 B1 teaches of having water pumps as the key component to facilitate a closed loop system, although these water pumps are mainly powered by either electricity or natural resources such as wind, sunlight or waves which are erratic by nature. Chinese publication no. 1045290 A relies on the siphonic effect which is also dependent on the operation of water pumps to facilitate a closed loop flow path to continuously generate electricity.

Although all the teachings of the above prior art seek to provide a self-sustainable hydropower plant, these plants rely heavily on external mechanical components like hydraulic pumps and compressors, which are powered by fuel. Although U.S. Pat. No. 6,420,794 B1 teaches of water pumps powered by natural resources, the effectiveness of these type of pumps is highly dependent on the availability of these natural resources. Furthermore, the hydropower plant of this US patent must be located at a suitable geographical location for access to such natural resources in order to operate said pumps.

Mechanical components such as water pumps and compressors, which are under heavy usage, require periodic maintenance and have a limited lifespan due to deterioration of parts.

There remains a need to develop a hydropower plant, which can be operational without relying heavily on the continuous operation of such mechanical components to achieve a closed loop system for generating electricity. In other words, there is a need to provide a self-adaptive and self-sustainable hydropower plant that can operate in a closed loop system without relying on geographic location to generate electricity.

### SUMMARY OF INVENTION

In a first aspect of the invention, there is provided a self-adaptive hydropower plant that enables a continuously circulating volume of water within a closed loop flow path for generating electricity.

The plant comprises a primary reservoir for storing and providing a supply of water; a storage tank elevated above the primary reservoir for receiving water from the primary reservoir and facilitating a flow of water from the tank to the primary reservoir; a diaphragm within the storage tank for defining upper and lower chambers of the tank, the diaphragm being vertically moveable within the tank; a plurality of secondary reservoirs located at an elevation below the storage tank but above the primary reservoir; at least one turbine positioned below the secondary reservoirs but above the primary reservoir for generating electricity from water distributed from the secondary reservoirs to the primary reservoir; and a system controller for controlling and monitoring the flow of water from the primary reservoir to the storage tank and secondary reservoirs.

Movement of the diaphragm within the storage tank facilitates the distribution of water from the tank into the secondary reservoirs; the secondary reservoirs being adapted to facilitate the distribution of water to the turbine and the movement of the diaphragm within the storage tank being in synchrony with the secondary reservoirs to initiate replenishment of water in the tank by the primary reservoir. The water in the primary reservoir is selectively distributed to the storage tank and the secondary reservoirs to reduce water loss.

The present invention was developed to introduce a hydropower plant that can be operational continuously without fuel and is able to continuously generate electricity even in the face of significant energy loss. The hydropower plant of this invention can continuously generate electricity without the need to be switched off (without a rest mode). The invention generally has impact for energy mix and specifically for the supply of electricity with the concept of decentralization, reducing the cost related to the installation of pylons and cables for electricity distribution. The hydropower plant of the invention is inexpensive and is adaptable to any geographical location.

The invention seeks to provide a mechanism which is self-adaptive, self-sustainable and self-regulated by facilitating a flow of water in stages, from a high elevation to a low elevation, to rotate water turbines. Water pumps are only needed to initiate operation of the closed loop system and to replenish water in the system as and when it is needed. Once the closed loop system is initialized and begun, external electricity is no longer required in the closed loop system to operate the pumps. The closed loop system of the invention is able to continuously operate on its own to generate electricity.

In an embodiment, the secondary reservoirs may comprise a second reservoir, a third reservoir and a fourth reservoir. The second reservoir is located at an elevation lower than and receiving water from the storage tank. The third reservoir is located at an elevation lower than and receiving water from the second reservoir, and the fourth reservoir is located at an elevation lower than and receiving water from the second and third reservoirs. The second reservoir is moveable upward and downward in sync with the movement of the diaphragm within the storage tank, and the third reservoir is movable upward and downward in opposite direction to the movement of the diaphragm and second reservoir. The water in the fourth reservoir is discharged onto the turbine which is located at an elevation lower than the fourth reservoir, and the water from the turbine is collected by the primary reservoir located at an elevation lower than the fourth reservoir and the turbine.

The storage tank may further comprise a connecting rod, a first end of the rod connected to the lower portion of the diaphragm and a second end extending downward and protruding through the base of the storage tank and fixed to the base of the second reservoir.

The plant may further comprise a pulley mechanism to synchronize the movement of the diaphragm and second reservoir and third reservoir during distribution of water within the secondary reservoirs such that, when the diaphragm and second reservoir move downward, the third reservoir moves upward and when the third reservoir moves downward, the diaphragm and second reservoir move upward.

The plant may further comprise a linear guide assembly provided to the second and third reservoirs. The assembly comprising at least two guide rails positioned on opposing sides of each of the second and third reservoirs, a plurality of linear guides and bearings being moveably supported on the guide rails; and at least two stoppers positioned at the end of the guide rails for limiting the movement of the second and third reservoirs once the base of both the second and third reservoirs abut the stoppers.

When the supply of water is discharged from the storage tank into the second reservoir, the diaphragm moves downward in synchrony with the downward movement of the second reservoir such that a vacuum is created in the upper chamber of the tank which triggers a supply of water to be delivered from the primary reservoir to replenish the water in the tank. When the supply of water is discharged from the second reservoir to the third and fourth reservoirs, the flow of water into the third reservoir causes the third reservoir to move downward, which causes the diaphragm to move upward together with the second reservoir.

According to an embodiment, the storage tank may further comprise first and second position-detecting sensors for detecting the position of the diaphragm within the tank.

In another embodiment, the plant may further comprise a plurality of suction pipes for delivering a supply of water from the primary reservoir to the storage tank. Each of the suction pipes may be provided with a check valve operable to prevent the water delivered to the storage tank from flowing back to the primary reservoir.

In a further embodiment, the plant may further comprise a plurality of control valves provided in each of the storage tank and the secondary reservoirs, the valves operable by the system controller to facilitate the distribution of water from the tank and secondary reservoirs.

In an embodiment, the plant may further comprise a plurality of sensors provided in each of the storage tank and the secondary reservoirs, for monitoring the water supply in the tank and the reservoirs.

According to another embodiment, the storage tank may comprise an enclosed cylindrical tank with an oval-shaped top portion, an elongated body, a funnel-shaped base and an outlet gate disposed at the bottom portion of the funnel-shaped base.

The storage tank may further comprise a plurality of bearings and seals provided at the top portion and the base to seal the area between the pulley mechanism connected to the diaphragm and the top portion and the area between the connecting rod and the bottom portion of the base.

According to a further embodiment, the diaphragm may comprise at least two openings for allowing water to flow therethrough, and at least two flippers fixedly hinged to the center of the diaphragm for opening and closing the openings. When the diaphragm moves downward, the flippers are closed to prevent water from flowing from the lower chamber of the storage tank into the upper chamber, and when said diaphragm moves upward, the flippers are opened to facilitate movement of water from the upper chamber into the lower chamber.

In an embodiment, the plant may further comprise a vent pipe connected to the storage tank for facilitating the release of air from the upper compartment of the tank. The vent pipe may be provided with a release valve and a sensor operable by the system controller.

In another embodiment, the plant may further comprise at least one power generator mechanically connected to the turbine for generating electricity.

In another embodiment, the surplus electricity generated by the power generator is stored in a storing means.

In a further embodiment, the plant may further comprise an alternative source of water for supply to the secondary reservoirs. The alternative source of water may be positioned at an elevation above the secondary reservoirs.

The alternative source of water may be a supplementary water source for the primary reservoir and be positioned between the fourth reservoir and the primary reservoir.

The alternative source of water may be a supplementary water source for the primary reservoir and/or the third reservoir.

In an embodiment, the primary reservoir may comprise a municipal water reservoir.

In another embodiment, the plant may further comprise at least one additional reservoir connected to the fourth reservoir.

According to an embodiment, the plant may further comprise a plurality of pumping means operable by the system controller for pumping a supply of water from the primary reservoir to the storage tank and the secondary reservoirs.

The pumping means may be operable to initialize the closed loop flow path by pumping a supply of water from the primary reservoir into the storage tank and fourth reservoir.

The pumping means may be operable to replenish water in the storage tank and/or third reservoir, by initiating water flow from the primary reservoir, when the sensors in the tank and the reservoir detects that the water level in the tank and reservoir is less than the predetermined minimum level of water.

The pumping means may be operable to replenish water in the fourth reservoir, by initiating water flow from the primary reservoir, when the sensors in the reservoir detects that the water level in the reservoir is less than the predetermined minimum level of water. The pumping means may comprise a plurality of water pumps.

In a second aspect of the invention there is provided a self-adaptive hydropower plant system. The system comprises more than one hydropower plant of the invention, the plants integrated into a network of plants for generating electricity.

The plants may operate independently of each other to facilitate continuous recirculation of a controlled volume of water within a closed loop flow path for rotating a turbine is connected to a generator for generating electricity.

The plants may share a primary reservoir and a fourth reservoir. The shared primary reservoir may supply water to each of the storage tanks of the hydropower plants. The shared fourth reservoir may collect water from each of the second reservoirs and third reservoirs of the hydropower plants. The shared fourth reservoir may release water to the shared primary reservoir to drive the turbine which is connected to a generator for generating electricity.

### BRIEF DESCRIPTION OF THE DRAWINGS

The present invention will become more clearly understood from the following description of the embodiments thereof, when taken in conjunction with the accompanying drawings. However, the embodiments and the drawings are given only for the purpose of illustration and explanation and are not to be taken as limiting the scope of the present invention, the scope of which is to be determined by the appended claims.

In the accompanying drawings, like reference numerals are used to denote like parts throughout several views.

FIG. 1 is a diagrammatic sectional view of the self-adaptive hydropower plant according to an embodiment of the invention.

FIG. 2 is a diagrammatic sectional view of the first stage of initialization of the invention.

FIG. 3 is a diagrammatic sectional view of the second stage in which the diaphragm is at position X.

FIG. 4 is a diagrammatic sectional view of the third stage in which the diaphragm moves from position X to Y.

FIG. 5 is a diagrammatic sectional view of the fourth stage in which the diaphragm is at position Y.

FIG. 6 is a diagrammatic sectional view of the fifth stage in which the diaphragm moves from position Y to X.

FIG. 7 is a detailed view of the diaphragm and its features illustrated by the plan view of FIG. 7A, cross-section A-A view of FIG. 7B, bottom view of FIG. 7C and cross-sectional views of the diaphragm in operation in FIG. 7D.

FIG. 8 is a flow chart of the process of the hydropower plant of this invention.

FIG. 9 is a diagrammatic sectional view of another embodiment of the invention incorporating an alternative water source.

FIG. 10 is a diagrammatic sectional view of a self-adaptive hydropower plant system comprising three hydropower plants of FIG. 1.

FIG. 11 is a diagrammatic sectional view of another embodiment of a self-adaptive hydropower plant system comprising five hydropower plants of FIG. 1.

FIG. 12 is a diagrammatic sectional view of an exemplary set up for the hydropower plant system.

FIG. 13 is a plan view of the layout of different embodiments of the hydropower plant systems comprising a first system of thirty-two plants, a second system of twenty-one plants and a system of twelve plants.

### DETAIL DESCRIPTION OF THE INVENTION

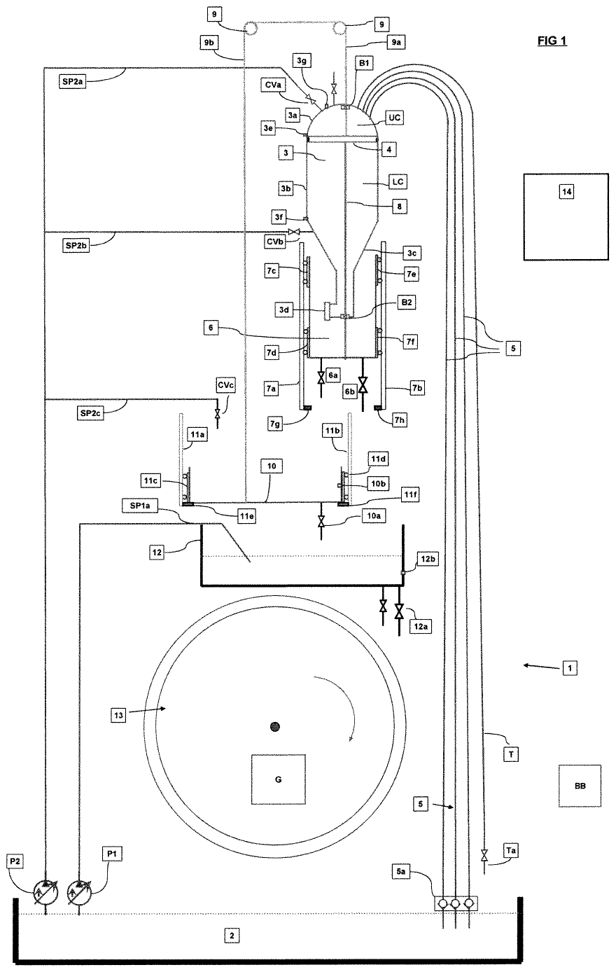

FIG. 1 is a diagram which illustrates an embodiment of a self-adaptive hydropower plant 1 comprising a primary reservoir 2, a storage tank 3, a diaphragm 4, three suction pipes 5, a second reservoir 6, a connecting rod 8, a pulley mechanism 9, a third reservoir 10, a fourth reservoir 12, a water turbine 13, a system controller 14 and two standby pumps P1, P2.

Water is the primary medium used in the embodiment. Any other liquid with low viscosity and lower density than water with suitable composition and chemical properties may also be used to substitute water. One of the main advantages of this invention is that it enables close monitoring and controlling of the closed loop flow path of the hydropower plant 1 to ensure that the plant operates efficiently to generate electricity continuously 24 hours a day, 7 days a week, preventing any potential loss of energy due to loss of water at any stage of the plant. Any water loss is rectified by replenishing the water supply to ensure continuity of the closed loop flow path. Once the flow of water begins, the flow path continues without pause to ensure continuous operation of the water turbine 13.

The hydropower plant 1 can be installed at any location and is not limited by suitability (or not) of a geographical location. The self-sustainable and self-adaptive features of the hydropower plant 1 contributes to the objectives of zero emissions of green-house gas or carbon dioxide, as well as ensuring that the system has a high efficiency rate of 100% or more in which the energy output is more than energy input. This invention is easily adaptable in different configurations to meet different needs.

The hydropower plant 1 comprises first or primary, second, third and fourth reservoirs 2, 6, 10, 12 installed at specific locations relative to the position of the storage tank 3 as illustrated in FIG. 1. The first, second, third and fourth reservoirs 2, 6, 10, 12 may be made of stainless steel. The same reservoirs can also be made of other materials such as plastic, galvanized steel, fiberglass and any other equivalent material to form a container. The primary reservoir 2 functions as the primary water reservoir to store and supply water to the hydropower plant 1. The second, third and fourth reservoirs, 6, 10, 12 are secondary reservoirs located at an elevation lower than the storage tank for facilitating the flow of water to be discharged to the water turbine 13. In this embodiment, the primary reservoir 2 has a rectangular shape with dimensions of 6.0 m length, 6.0 m width and 6.0 m height and has a capacity to store 54.0 m³ of water.

The storage tank 3 is an enclosed tank, which is air-tight, has an oval-shaped top portion 3a, an elongated body 3b, a funnel-shaped base 3c and an outlet gate 3d provided at the bottom portion of the funnel-shaped based 3c. The storage tank 3 has a dimension of 1.1 m height and internal diameter of 0.60 m. The storage tank may be made of stainless steel that can withstand pressure of at least 1.0 bar. The storage tank can also be made of other materials such as plastic, galvanized steel, carbon, alloy steel and any other equivalent material to form a container.

The storage tank 3 is positioned at the highest elevation relative to the primary reservoir 2, secondary reservoirs 6, 10, 12 and water turbine 13, at a vertical height of 12.5 m from ground level, above the second reservoir 6. The second reservoir 6 is positioned at a vertical height of 10 m from ground level, which is the lowest position point.

An outlet gate 3d is provided at the bottom portion of the funnel-shaped base 3c to facilitate release of water from the storage tank 3 into the second reservoir 6. Controlled operation of the outlet gate 3d is monitored by the system controller 14 through a control valve 3dx installed at the outlet gate 3d. Opening and closing of the outlet gate 3d is dependent on the positioning of the diaphragm 4 with respect to a set of predetermined positions X and Y within the storage tank 3. A sensor 3g is provided on the inner face of the exterior side wall of the storage tank 3 to monitor the water level in the storage tank 3. The sensor 3g is connected to the system controller 14.

The diaphragm 4 is positioned within the storage tank 3 such that it defines an upper compartment UC and lower compartment LC in the elongated body 3b of the storage tank 3. The diaphragm 4 is moveable upward and downward between positions X and Y along the body 3b of the storage tank 3 to facilitate the flow of an incoming supply of water from the primary reservoir 2 delivered through the suction pipes 5 as well as to initiate the replenishment of water into the storage tank 3 from the primary reservoir 2. The diaphragm 4 has a series of check valves and control valves installed and functions to facilitate the water to flow from the upper compartment UC to the lower compartment LC of the storage tank 3 when the diaphragm 3 moves between positions X and Y. The predetermined position X is configured to be at the upper compartment UC of the storage tank 3 at a vertical height of 1.0 m relative to the base of the tank 3. The predetermined position Y is configured to be at the lower compartment LC of the tank 3 at a vertical height of 0.35 m relative to the base of the tank 3. The predetermined position Y is at the end portion of the elongated body 3b or the top portion of the funnel-shaped base 3c of the tank 3. The end portion of the elongated body 3b coincides with the top portion of the funnel-shaped base 3c of the tank 3. The first position sensor 3e is provided at the upper compartment UC of the tank 3 to detect the positioning of the diaphragm 4 with respect to position X. The second position sensor 3f is provided at the lower compartment LC of the tank 3 to detect the positioning of the diaphragm 4 with respect to position Y. The diaphragm 4 facilitates the movement of water in the elongated body 3b to the funnel-shaped base 3c of the tank 3. At a predetermined time, the outlet gate 3d is operable by the system controller 14 to release water in the funnel-shaped base 3c of the tank 3 into the second reservoir 6.

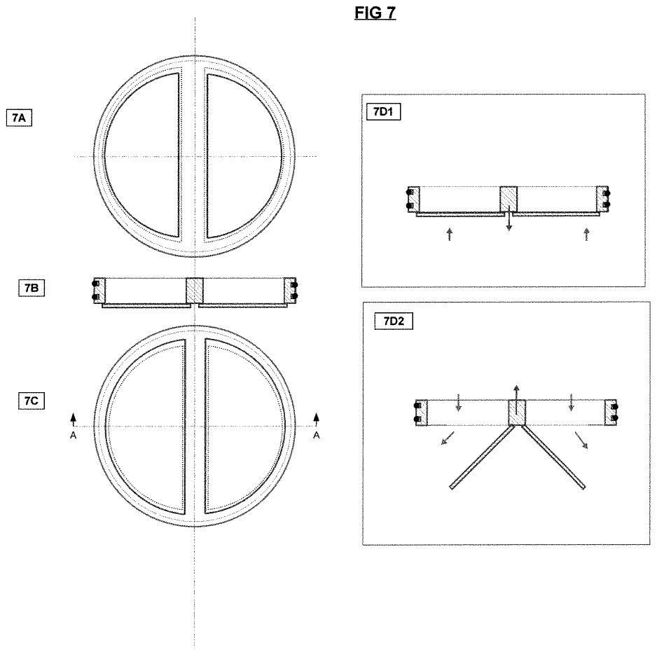

During the downward movement of the diaphragm 4 within the storage tank 3, the diaphragm 4 prevents water from flowing from the lower compartment LC to the upper compartment UC of the tank 3. The design of the diaphragm 4 is illustrated in FIG. 7. The diaphragm 4 is connected to the second reservoir 6 by way of the connecting rod 8, which penetrates through the funnel-shaped base 3c of the tank 3. A set of bearing and seal B2 is provided at the funnel-shaped base 3c of the tank 3 to facilitate movement of the connecting rod 8, which guides the movement of the diaphragm 3 and the second reservoir 6.

The diaphragm 4 is supported by the pulley mechanism 9 and the connecting rod 8, which facilitates the movement of the diaphragm 4 in the storage tank 3. The rope 9a of the pulley mechanism 9 is connected to the upper portion 4a of the diaphragm 4. A set of bearing and seal B1 is provided at top portion of the tank 3 to facilitate the movement of the rope 9a of the pulley mechanism 9, which guides the movement of the diaphragm 3 and the second reservoir 6. The lower portion 4b of the diaphragm 4 is connected to the connecting rod 8. One end of the connecting rod 8 is connected to the lower portion 4b of the diaphragm 4 and the other end of the connecting rod 8 is fixedly connected or fixed to the base of the second reservoir 6.

Three suction pipes 5 each with a diameter of about 0.05 m are provided to deliver water from the primary reservoir 2 to the top portion 3a of the storage tank 3 by relying on a vacuum suction effect created in the tank 3. The suction pipes 5 may be made of copper or any other equivalent material. The tank 3 is air-tight. When water is discharged from the tank 3 to fill the second reservoir 6, the second reservoir 6 begins to move and slide downward due to the weight of the water therewithin. The downward movement of the second reservoir 6 guides the downward movement of the diaphragm 4 in the tank 3 moving from position X to position Y. This natural kinetic motion of the downward movement of the diaphragm 4 in the tank 3 results in a vacuum space in the upper compartment UC of the tank 3. This vacuum space in the upper compartment UC of the tank 3 creates a vacuum suction effect, which initiates the suction of water from the primary reservoir 2 into the upper compartment UC of the tank 3 by way of the three suction pipes 5. Each of the suction pipe 5 is installed with check valves 5a to prevent the water delivered to the tank 3 from flowing back to the primary reservoir 2 due to gravitational effect. A vent pipe T is connected to the oval-shaped top portion 3a of the tank 3 to release air from the upper compartment UC of the tank 3. This vent pipe T is installed with an air release control valve Ta, which comes with a sensor operable by the system controller 14.

In this embodiment, the second reservoir 6 has a rectangular shape with dimensions of 0.6 m length, 0.6 m width and 0.6 m height and has a capacity to store 0.216 m³ of water. The second reservoir 6 is positioned at an elevation below that of the storage tank 3. The second reservoir 6 is moveable upwards and downwards with the guidance of four sets of linear guides and bearings 7c, 7d, 7e, 7f and two guide rails 7a, 7b. Each of the two guide rails 7a, 7b is positioned on both opposing exterior sides of the second reservoir 6. The first set of linear guide and bearing 7c, 7d is provided at one of the exterior side of the second reservoir 6 and the second set of linear guide and bearing 7e, 7f is provided at the other exterior side of the second reservoir 6. The first set of linear guide and bearing 7c, 7d is moveable along the first guide rail 7a and the second set of linear guide and bearing 7e, 7f is moveable along the second guide rail 7b. Two stoppers 7g, 7h are installed at the bottom of the first and second linear guide rails 7a, 7b, respectively.

Two control valves 6a, 6b are provided at the base of the second reservoir 6. Each control valve 6a, 6b is operable by the system controller 14 to facilitate the release of water from the base of the second reservoir 6 into the third reservoir 10 and fourth reservoir 12, respectively. When the base of the second reservoir 6 abuts the stoppers 7g, 7h, the system controller 14 opens the control valves 6a, 6b to release water from the second reservoir 6 into the third reservoir 10 and fourth reservoir 12, respectively. When the base of the second reservoir 6 abuts the stoppers 7g, 7h, the diaphragm 4 is at position Y in the lower compartment LC of the storage tank 3.

In this embodiment, the third reservoir 10 has a rectangular shape with dimensions of 0.5 m length, 0.5 m width and 0.3 m height and has a capacity to store 0.075 m³ of water. The third reservoir 10 is positioned at a vertical height of 8.8 m from ground level, which is below the second reservoir 6. The third reservoir 10 is moveable upwards and downwards with the guidance of two sets of linear guides and bearings 11c, 11d and two guide rails 11a, 11b. Each of the two guide rails 11a, 11b is positioned on both opposing sides of the third reservoir 10. The first set of linear guide and bearing 11c is provided at one of the exterior side of the third reservoir 10 and the second set of linear guide and bearing 11d is provided at the other exterior side of the third reservoir 10. The first set of linear guide and bearing 11c is moveable along the first guide rail 11a and the second set of linear guide and bearing 11d is moveable along the second guide rail 11b. Two stoppers 11e, 11f are installed at the bottom of the first and second linear guide rails 11a, 11b, respectively.

When water from the second reservoir 6 is fully released into the third reservoir 10 and fourth reservoir 12, the third reservoir 10 pulls the rope 9b of the pulley mechanism 9, which triggers the upward movement of the diaphragm 4 and the second reservoir 6 until the diaphragm 4 reaches position X in the upper compartment UC of the storage tank 3. When water is released from the second reservoir 6 into the third reservoir 10, the weight of water in the third reservoir 10 gradually increases. The gradual increase of the weight of water in the third reservoir 10, which is higher than the weight of an empty second reservoir 6 creates a pulling effect which facilitates the upward movement of the diaphragm 4 and the second reservoir 6.

A control valve 10a is provided at the base of the third reservoir 10. A sensor 10b is provided on the inner face of the exterior side wall of the third reservoir 10 to monitor the water level in the third reservoir 10. The control valve 10a is operable by the system controller 14 to facilitate the release of water from the third reservoir 10 into the fourth reservoir 12. When the base of the third reservoir 10 abuts the stoppers 11e, 11f, the system controller 14 opens the control valve 10a to release water from the third reservoir 10 into the fourth reservoir 12. When the base of the third reservoir 10 abuts the stoppers 11e, 11f, the diaphragm 4 is at position X in the upper compartment UC of the storage tank 3.

In this embodiment, the fourth reservoir 12 has a rectangular shape with dimensions of 3.0 m length, 3.0 m width and 1.0 m height and has a capacity to store 9.0 m³ of water. The fourth reservoir 12 is positioned at a vertical height of 7.5 m from ground level, which is below the third reservoir 10. A control valve 12a is provided at the base of the third reservoir 10. A sensor 12b is provided on the inner face of the exterior side wall of the fourth reservoir 12 to monitor the water level in the fourth reservoir 12. The sensor 12b is connected to the system controller 14. The control valve 12a is operable by the system controller 14 to facilitate the release of water from the fourth reservoir 12 onto a water turbine 13. The water turbine 13 is positioned at a vertical height of 4.0 m from ground level measured from the center of the water turbine 13, which is below the fourth reservoir 12 and above the primary reservoir 2. The turbine 13 may comprise a Pelton, Kaplan or Francis-type turbine or water wheel.

Water from the fourth reservoir 12 is released onto the water turbine 13 and by virtue of gravitational force, the incoming water released from a higher altitude rotates the water turbine 13, which is mechanically connected to the generator G to generate electricity. The electricity generated by the generator G is supplied to the consumer or a power grid. Surplus electricity is stored in a storing means BB such as a battery bank. The stored electricity can be supplied to the consumer or power grid as controlled by the system controller 14.

Water which is released from the fourth reservoir 12 to rotate the water turbine 13 is collected by the primary reservoir 2. The primary reservoir 2 is positioned at an elevation below that of the water turbine 13. The water collected in the primary reservoir 2 is re-used and recirculated in the hydropower plant 1, which facilitates a closed loop flow path of water for continuous generation of electricity.

A standby water pump P1 is provided to initiate the delivery of water from the primary reservoir 2 to the fourth reservoir 12 through a supply pipe SP1. A standby water pump P2 is provided to initiate the delivery of water from the primary reservoir 2 to the storage tank 3, second reservoir 7 and third reservoir 10 through a supply pipe SP2. The supply pipe SP2 branches and divided into three pipelines, SP2a, SP2b, SP2c to supply water from the primary reservoir 2 to the tank 3, and the third reservoir 10, respectively. The first and second supply pipes SP2a, SP2b are connected to the upper compartment UC and lower compartment LC of the tank 3, respectively. The first and second supply pipes SP2a, SP2b are each provided with control valves CVa, CVb to facilitate the supply of water from the primary reservoir 2 to the tank 3. The third supply pipe SP2c is provided to supply water from the primary reservoir 2 to the third reservoir 10. The third supply pipe SP2c is provided with a control valve CVc to facilitate the supply of water from the primary reservoir 2 to the third reservoir 10. Operation of the first, second and third supply pipes SP2a, SP2b, SP2c is controlled by the system controller 14.

These standby pumps P1, P2, which are controlled by the system controller 14 are provided to start the hydropower plant 1 by initiating the flow of water from the primary reservoir 2 to the storage tank 3 and the fourth reservoir 12. In the event that the water supply in the tank 3 and the fourth reservoir 4 is detected by the sensors 3g, 12b to be lower than a predetermined level of water, the system controller 14 triggers the standby pumps P1, P2 to provide more water from the primary reservoir 2 to either the tank 3 and/or fourth reservoir 12 to ensure sufficient water is always provided to the water turbine 13 to continuously generate electricity. After the initialization of the hydropower plant 1, no external electricity is required to operate the standby pumps, P1, P2. The surplus electricity stored in the storing means BB can be used to operate the pumps P1, P2 as and when it is required.

The controlled volume of water continually recirculates from the primary reservoir 2 to the storage tank 3 and the second, third and fourth reservoirs 6, 10, 12 and onto the water turbine 13 which then returns the water to the primary reservoir 2 to complete one cycle of the closed loop flow path. Operation of the tank 3 adapted with the diaphragm 4 and the second reservoir 6 and third reservoir 10 connected with the pulley mechanism 9 facilitates the self-adaptive feature of the plant of the invention in which the water supply is continually flowing from the tank 3 into the fourth reservoir 12 without any additional external power input such as a pump.

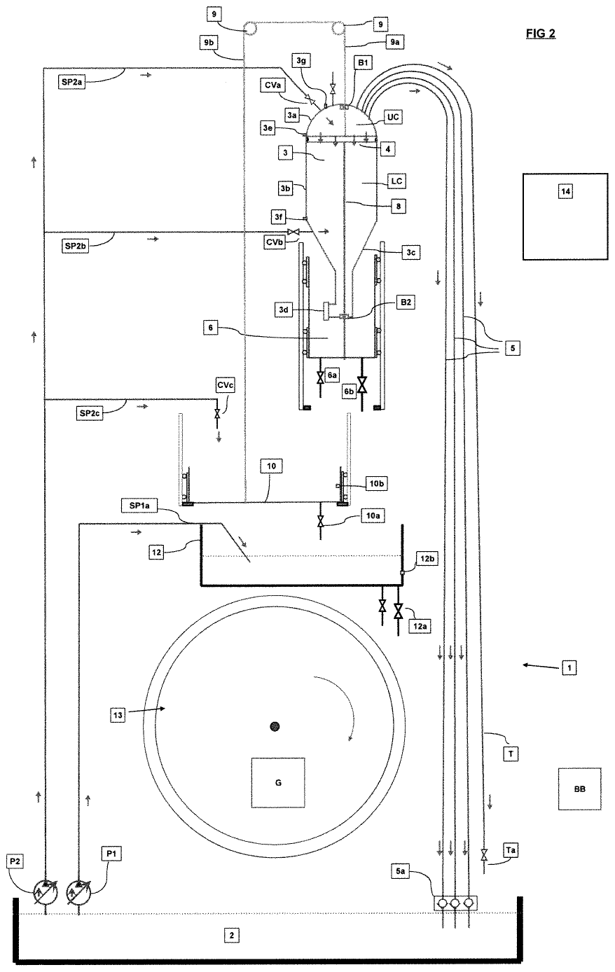

FIG. 2 illustrates the first stage of initialization of the self-adaptive hydropower plant 1. To start the process in the hydropower plant 1, the standby water pump SP2 pumps the water from primary reservoir 2 into the upper compartment UC of the storage tank 3 through the standby supply pipe SP2. The control valve CVa is opened to release water from the primary reservoir 2 into the upper compartment UC of the tank 3 through the first supply pipe SP2a. At this time, the outlet gate 3d of the tank 3 is closed. The air release control valve Ta is opened to release excess air in the tank 3 through the vent pipe T. The flow of water from the primary reservoir 2 through the first supply pipe SP2a continues until the tank 3 is detected by the air release control valve Ta and sensor 3g to be completely filled up with water. The system controller 14 then switches off the standby water pump P2 to stop the delivery of water from the primary reservoir 2 into the tank 3. At this initialization stage, there is no suction effect yet in the tank 3. The standby water pump P1 pumps water from the primary reservoir 2 into the fourth reservoir 12 through the supply pipe SP1. The control valve 12a which is provided at the base of the fourth reservoir 12 is closed.

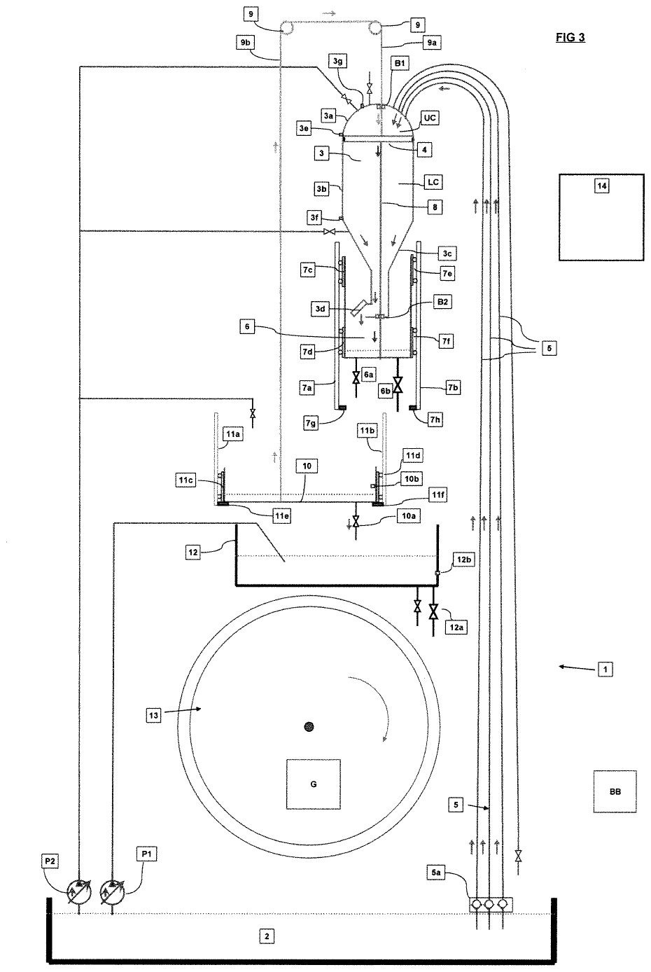

FIG. 3 illustrates the second stage of the hydropower plant 1 after the initialization stage, in which the diaphragm 4 is at position X. The position and movement of the diaphragm 4 within the storage tank 3 is detected by the first and second position sensors 3e, 3f and is monitored by the system controller 14. The outlet gate 3d of the tank 3 remains closed. The water potential energy in the lower compartment LC of the tank 3 is in standby mode. At this stage, the whole system of the hydropower plant 1 is in ready mode to start the closed-loop flow path to generate electricity.

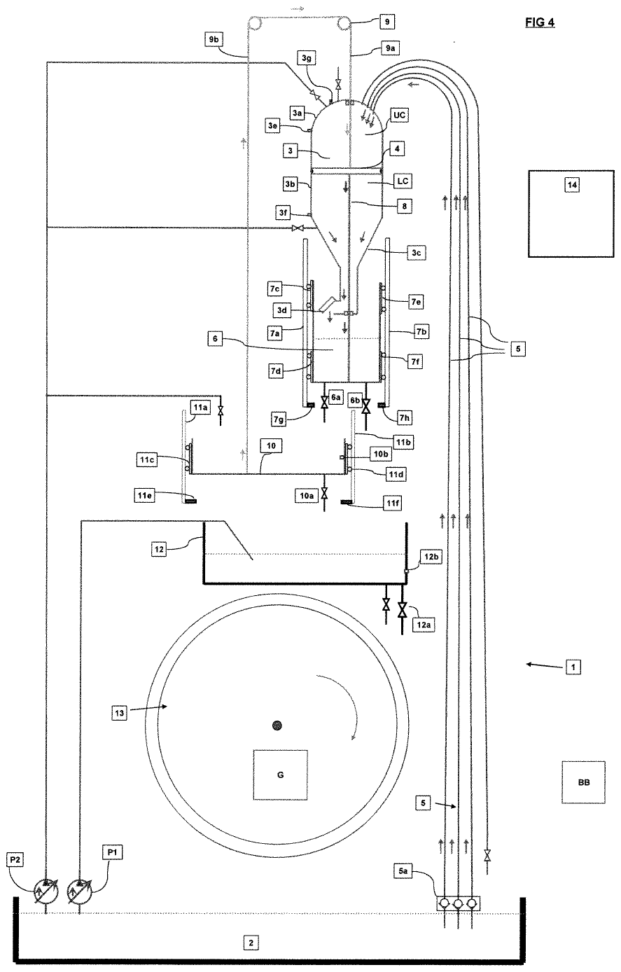

FIG. 4 illustrates the third stage of the hydropower plant 1 in which the diaphragm 4 moves downward from its original position X to position Y in the storage tank 3. At this stage, the outlet gate 3d of the tank 3 is opened by the system controller 14. The downward movement of the diaphragm 4 triggers the release of water from the tank 3 into the second reservoir 6. At this juncture, there is no water in the third reservoir 10. This process continues until the second reservoir 6 is completely filled up with water from the tank 3. The increasing weight of water in the second reservoir 6 triggers the downward movement of the second reservoir 6 by virtue of gravitational force. The downward movement of the second reservoir 6 is guided by the four sets of linear guides and bearings 7c, 7d, 7e, 7f and two guide rails 7a, 7b. The downward movement of the second reservoir 6 pulls the diaphragm 4 to move downward from position X to position Y through the connecting rod 8. The second reservoir 6 moves downward until its base abuts the two stoppers 7g, 7h at the bottom end of the two guide rails 7a, 7b. The movement of the diaphragm 4 from position X to position Y creates a vacuum space in the upper compartment UC of the tank 3. This vacuum created in the upper compartment UC of the tank 3 creates a vacuum suction effect in which the water in the primary reservoir 2 is sucked and delivered to the upper compartment UC of the tank 3 through the three suction pipes 5. The creation of this vacuum space in the upper compartment UC of the tank 3 is essential to replenish water in the tank 3, to ensure that the closed loop flow path is always in operation.

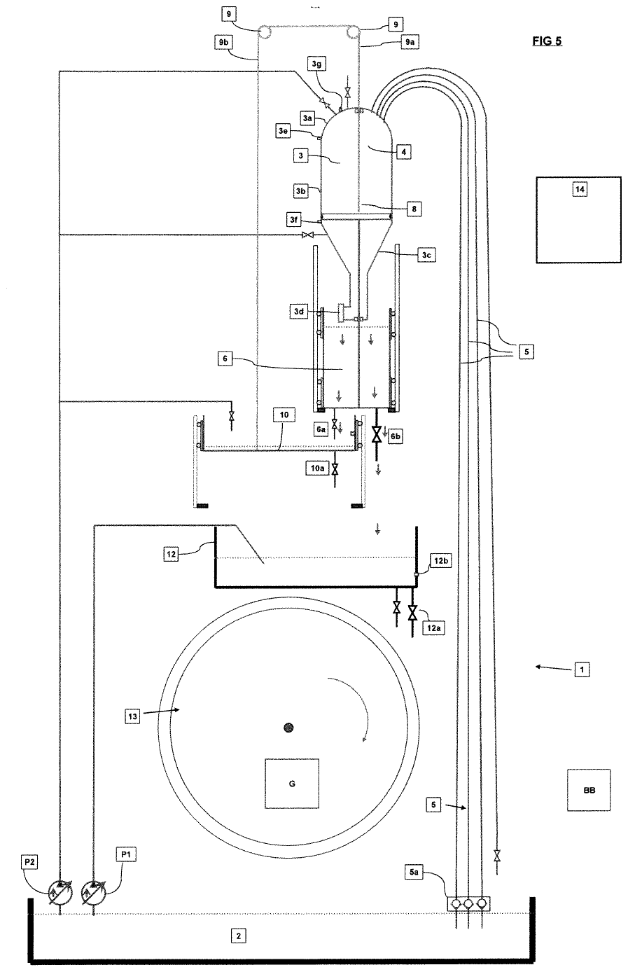

FIG. 5 illustrates the fourth stage of the hydropower plant 1 in which the diaphragm 4 is detected by the position sensor 3f to be at position Y. Once the diaphragm 4 is detected at position Y, the system controller 14 closes the outlet gate 3d of the storage tank 3 to stop the release and discharge of water from the tank 3 into the second reservoir 6. When the diaphragm 4 is detected at position Y, the base of the second reservoir 6 abuts the two stoppers 7g, 7h provided at the bottom end of the two guide rails 7a, 7b. The system controller 14 opens the control valves 6a, 6b to discharge water from the second reservoir 6 into the third reservoir 10 and fourth reservoir 12.

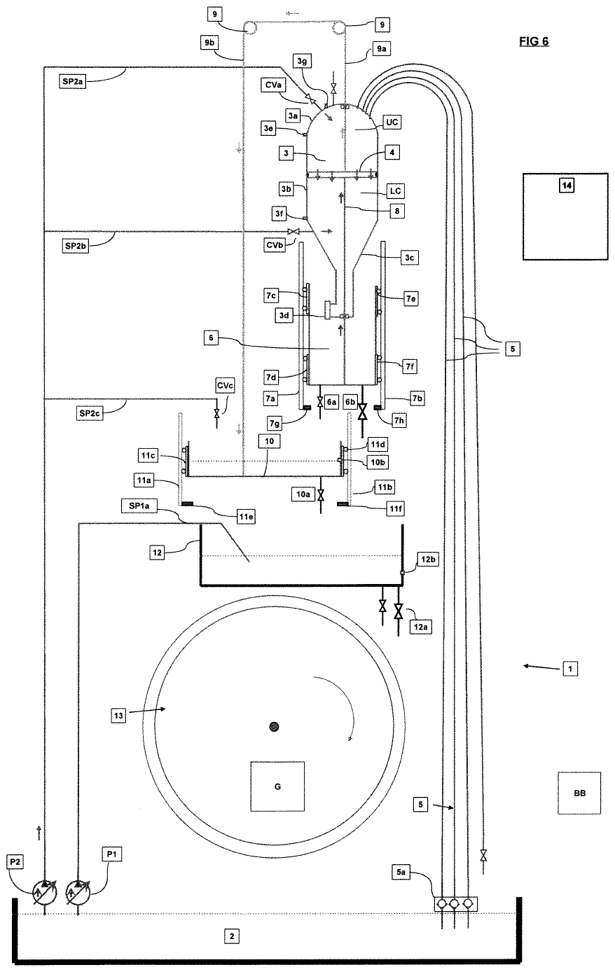

FIG. 6 illustrates the fifth stage of the hydropower plant 1 in which the diaphragm 4 is moving upwards to return to position X from its current position Y. As water is discharged from the second reservoir 6 into the third reservoir 10 and fourth reservoir 12, the total weight of the third reservoir 10 gradually increases. At the same time, the total weight of the second reservoir 6 gradually decreases. At this time, the third reservoir 10 moves downward guided by two sets of linear guides and bearings 11c, 11d and two guide rails 11a, 11b and concurrently pulls the rope 9b of the pulley mechanism 9 which in turn pulls up the rope 9a connected to the diaphragm 4 to trigger the upward movement of the diaphragm 4 from position Y to position X and the second reservoir 6. Concurrently, the remaining water in the upper compartment UC of the tank 3 flows to the lower compartment LC of the tank 3. The downward movement of the third reservoir 10 stops once the diaphragm 4 returns to its original position X as detected by the position sensor 3e. The downward movement of the third reservoir 10 is stopped when the base of the third reservoir 10 abuts the two stoppers 11e, 11f at the bottom of the two guide rails 11a, 11b. The return of the diaphragm 4 from position Y to original position X completes one cycle of the hydropower plant 1.

The fourth reservoir 12 receives water from the second reservoir 6. To initiate the next cycle of the hydropower plant 1, water in the third reservoir 10 is discharged through the opening of the control valve 10a operated by the system controller 14. The fourth reservoir 12 continuously receives water from both the second reservoir 6 and third reservoir 10 at different predetermined periods. The discharge of water from the fourth reservoir 12 onto the water turbine 13 is controlled by the system controller 14. The system controller 14 triggers the discharge of water from the fourth reservoir 12 downward onto the water turbine 13 through the opening of the control valve 12a. The discharge of water from the fourth reservoir 12 at a higher altitude to the water turbine 13 at a lower altitude rotates the water turbine 13 by virtue of gravitational force. The water turbine 13 is a rotary mechanical machine that converts the potential energy and kinetic energy due to the movement of water into electricity. The water turbine 13 is connected to a shaft and rotation of the turbine caused by movement of a large volume of water, initiates the generation of electricity. The torque generated turns the shaft of the generator G to generate electricity.

The flow rate of water and the diameter of the water turbine 13 will determine the amount of torque generated and the amount of electricity produced. The system controller 14 monitors the revolution of the water turbine 13, the power output, the water levels in the fourth reservoir 12 and primary reservoir 2, the water flow rate and operation of the plurality of control valves CVa, CVb, 6a, 6b, 10a, 12a in a timely manner to ensure continuous supply of water onto the water turbine 13.

The standby water pump P1 acts as a backup pump to deliver water from the primary reservoir 2 to the fourth reservoir 12 to ensure continuity of water supply in the fourth reservoir 12 to rotate the water turbine 13. The continuous supply of water in the hydropower plant 1 ensures continuous generation of electricity.

The water discharged from the fourth reservoir 12 to rotate the water turbine 13 is collected by the primary reservoir 2. This completes the cycle of the hydropower plant 1. The water in the primary reservoir 2 is recirculated and re-delivered to the storage tank 3 to initiate repetition of the full cycle to ensure a closed loop path of water flow to drive the water turbine 13.

The following Tables 1 illustrates the parameters for configuring a self-adapting hydropower plant 1 which provides 2 kW of electricity. The setup of the system is modular and is scalable to support various system capacity requirements.

TABLE 1

| Parameter (Reference) | Unit | Value |
|---|---|---|
| Storage Tank [3] | | |
| Internal Diameter | m | 0.60 |
| Tank Height | m | 1.10 |
| Height from X to Y | m | 0.65 |
| Height from X to Top of Tank | m | 0.10 |
| Height from Y to Bottom of Tank | m | 0.35 |
| Estimated Cycle Time (X to Y to X) | s | 6 |
| Estimated Cycle per min | cycle/min | 10 |
| Estimated Flow Rate per cycle | L/cycle | 183 |
| Diaphragm [4] | | |
| Diaphragm Outer Diameter with O-ring | m | 0.60 |
| Diaphragm Thickness | m | 0.03 |
| Second Reservoir [6] | | |
| Size: L × W × H | m³ | 0.6 × 0.6 × 0.6 |
| Estimated Flow Rate per cycle | L/cycle | 183 |
| Estimated Weight of Second Reservoir | kg | 12 |
| (Empty) | | |
| Estimated Weight of Second Reservoir | kg | 195 |
| (Loaded) | | |
| Third Reservoir [10] | | |
| Size: L × W × H | m³ | 0.5 × 0.5 × 0.3 |
| Forth Reservoir [12] | | |
| Size: L × W × H | m³ | 3 × 3 × 1 |
| First Reservoir [2] | | |
| Size: L × W × H | m³ | 6 × 6 × 1.5 |
| Suction tubes [5] | | |
| Tube Diameter | m | 0.05 |
| Water Turbine [13] | | |
| Water Turbine Diameter | m | 5 |
| Water Turbine Radius | m | 2.5 |
| Power Generator [G] | | |
| Estimated Power Output | kW | 2 |

FIG. 7 illustrates the design and configuration of the diaphragm 4 in a plan view in FIG. 7A, a cross-sectional A-A view of FIG. 7A in FIG. 7B, a bottom view in FIG. 7C and cross-sectional A-A views of the diaphragm 4 in operation in FIG. 7D. The diaphragm 4 may be made of plastic or any equivalent material which has a lower density than water at 1.0 g/m³ and can withstand a minimum pressure of 1.0 bar. The diaphragm 4 moves upward from position Y to X within the storage tank 3 as water flows from the upper compartment UC into the lower compartment LC of the tank 3 as shown in FIG. 3. As shown in FIGS. 7B and 7D, the diaphragm 4 is provided with two flippers 4x, 4y. In this embodiment, the diaphragm 4 has a dimension of 0.03 m thickness and 0.6 m diameter. The two flippers 4x, 4y are hinged at the center portion C of the diaphragm 4. The two flippers 4x, 4y act as tidal gates to facilitate the opening and closing of two openings Ox, Oy provided on the diaphragm 4. The openings Ox, Oy of the diaphragm 4 is illustrated in FIGS. 7A and 7D.

In FIG. 7D1, when the diaphragm 4 moves downward in the storage tank 3 as shown in FIG. 3, the openings Ox, Oy are closed by the two flippers 4x, 4y to prevent water flow from the lower compartment LC to the upper compartment UC in the tank 3 as shown in FIG. 3. The downward movement of the diaphragm 4 in the tank 3 creates a vacuum in the upper compartment UC of the tank 3.

In FIG. 7D2, when the diaphragm 4 moves upward in the tank 3 as shown in FIG. 6, the flippers 4x, 4y flip downwards to allow water from the upper compartment UC into the lower compartment LC of the tank 3.

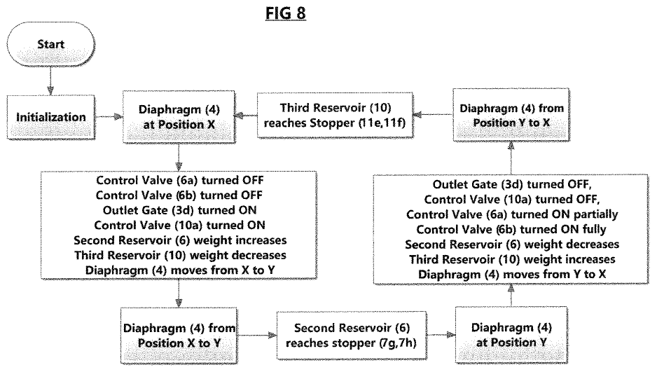

FIG. 8 is a flow chart that illustrates the complete cycle of the hydropower plant 1 as illustrated in the different stages elaborated in FIGS. 2 to 6. The hydropower plant 1 is configured by the system controller 14 to be at the initialization mode before the cycle is started. At the first stage of initialization of the hydropower plant 1, the diaphragm 4 is at position X to start the closed-loop flow path to generate electricity. The outlet gate 3d of the storage tank 3 is closed. The water potential energy in the lower compartment LC of the tank 3 is on standby mode.

The second and third stages is when the diaphragm 4, which is positioned at position X starts moving downward to position Y in the storage tank 3. At this stage, the outlet gate 3d of the tank 3 is opened by the system controller 14 to release water in the tank 3 to the second reservoir 6. The downward movement of the diaphragm 4 is in sync with the release of water from the tank 3 to the second reservoir 6. At this juncture, there is no water supply in the third reservoir 10. This process continues until the second reservoir 6 is completely filled with water released from the tank 3. The increasing weight of water in the second reservoir 6 triggers the downward movement of the second reservoir 6 by virtue of gravitational force. The downward movement of the second reservoir 6 is guided by the four sets of linear guides and bearings 7c, 7d, 7e, 7f and two guide rails 7a, 7b until the base of the second reservoir 6 abuts the two stoppers 7g, 7h provided at the bottom end of the two guide rails 7a, 7b.

The fourth stage is when the diaphragm 4 is detected by the position sensor 3f to be at position Y. When the diaphragm 4 is detected at position Y, the system controller 14 closes the outlet gate 3d of the storage tank 3 to stop the discharge of water from the tank 3 into the second reservoir 6. When the diaphragm 4 is detected at position Y, the base of the second reservoir 6 abuts the two stoppers 7g, 7h at the bottom end of the two guide rails 7a, 7b. The system controller 14 opens the control valves 6a, 6b to discharge water from the second reservoir 6 to the third reservoir 10 and fourth reservoir 12.

The fifth stage is when the diaphragm 4 moves upward from position Y and returns to position X. As water is discharged from the second reservoir 6 into the third reservoir 10 and fourth reservoir 12, the total weight of the third reservoir 10 gradually increases. At the same time, the total weight of the second reservoir 6 gradually decreases. At this juncture, the third reservoir 10 moves downward guided by two sets of linear guides and bearings 11c, 11d and two guide rails 11a, 11b and concurrently pulls the rope 9b of the pulley mechanism 9 which in turn pulls up the rope 9a connected to the diaphragm 4 to trigger the upward movement of the diaphragm 4 from position Y to position X and the second reservoir 6. Concurrently, the remaining water in the upper compartment UC of the storage tank 3 flows to the lower compartment LC. The downward movement of the third reservoir 10 stops once the diaphragm 4 returns to position X as detected by the position sensor 3e. The downward movement of the third reservoir 10 is stopped when the base of the third reservoir 10 abuts the two stoppers 11e, 11f at the bottom end of the two guide rails 11a, 11b. The return of the diaphragm 4 from position Y to position X completes one cycle of the hydropower plant 1.

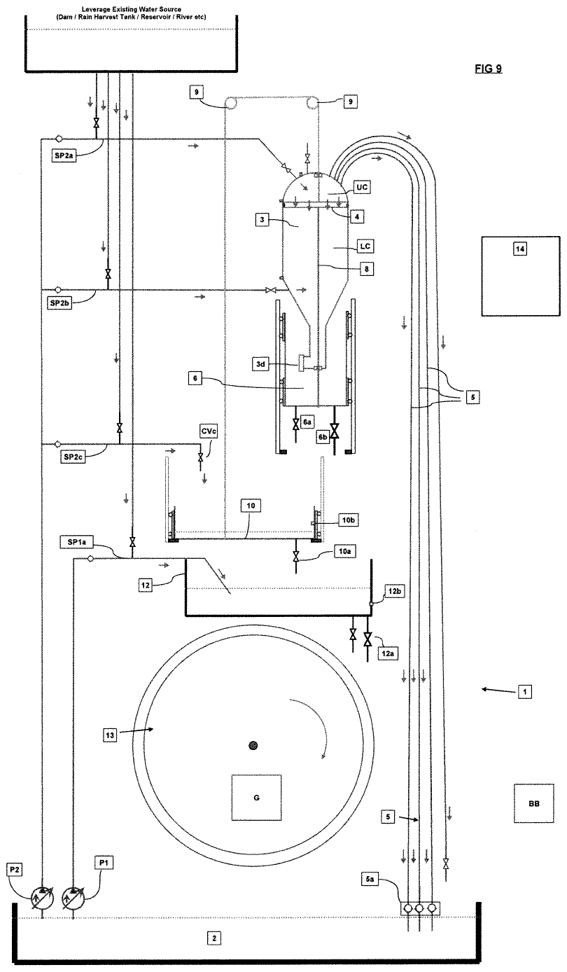

FIG. 9 illustrates another embodiment of the hydropower plant X1 to be used with an existing natural water source such as a river, lake, pond or an ocean. The hydropower plant X1 can be adapted to utilize any available alternative water source to complement the primary water source (primary reservoir 2). In addition, a man-made dam can also be used as an alternative water source Existing natural water sources provide an alternative water source for the fourth reservoir 12. The alternative water source must be located at an elevation higher than that of the fourth reservoir 12. In certain scenarios, the alternative water source may be located between the elevation of the fourth reservoir 12 and the primary reservoir 2, provided the alternative water source is at an elevation higher than that of the water turbine 13.

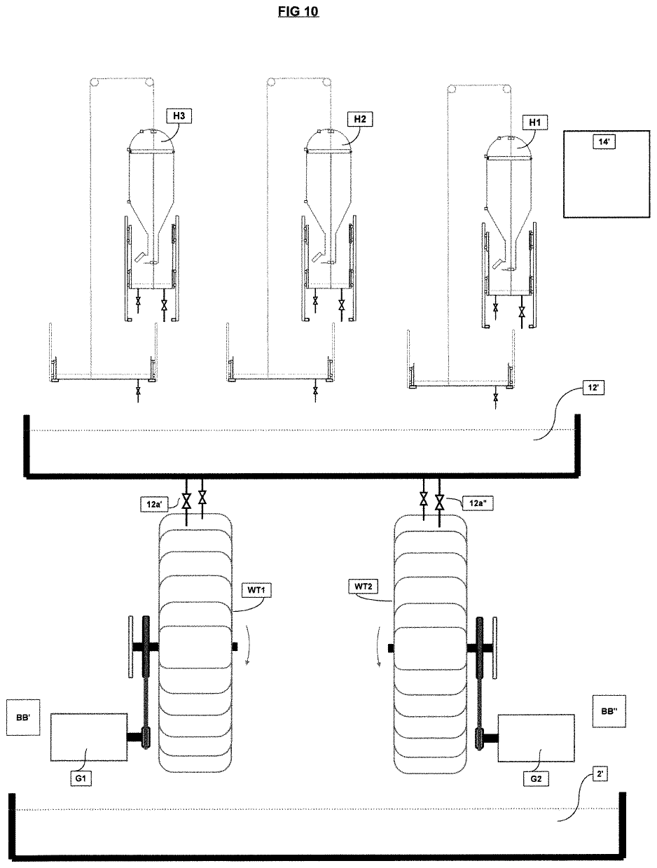

FIG. 10 illustrates another embodiment where the hydropower plant system integrates three hydropower plants H1, H2, H3. The hydropower plant system can comprise a network of multiple hydropower plants integrated to generate high electricity by the combination of the water turbines and plurality of generators. This hydropower plant system is scalable to meet higher demands of electricity, for example, to supply electricity to a row of houses, or a large office building, etc.

The system can have three hydropower plants H1, H2, H3 to drive two water turbines WT1, WT2 with each of the water turbines WT1, WT2 connected to its respective power generator G1, G2 for generating electricity. The electricity generated by the generators G1, G2 is supplied to the consumer or a power grid. Surplus electricity is stored in a storing means BB such as a battery bank. The stored electricity can be supplied to the consumer or power grid as controlled by a system controller 14′.

The system controller 14′ monitors and controls the operations of the three hydropower plants H1, H2, H3. Each of the three hydropower plants H1, H2, H3 comprises all of the components of the hydropower plant 1 as illustrated in FIG. 1, with the exception of a shared primary reservoir 2′ and a shared fourth reservoir 12′. With the exception of the shared primary reservoir 2′ and shared fourth reservoir 12′, all of the components of the hydropower plants H1, H2, H3 are identical in dimensions to the components of the hydropower plant 1 of FIG. 1. The shared primary reservoir 2′ is a rectangular shaped tank with a dimension of 9.0 m length, 8.0 m width and 1.5 m height and has a capacity to store 108.0 m³ of water. The shared fourth reservoir 12′ is a rectangular shaped tank with a dimension of 5.0 m length, 5.0 m width and 1.0 m height and has a capacity to store 25.0 m³ of water.

The three hydropower plants H1, H2, H3, operate independently of each other to produce water supply to be collected by the shared fourth reservoir 12′. Water in the shared fourth reservoir 12′ is discharged through the opening of the control valves 12a′, 12a″ to drive the two water turbines WT1, WT2. Operation of the control valves 12a′, 12a″ is controlled by the system controller 14. The water discharged from the shared fourth reservoir 12′ to rotate the two water turbines WT1, WT2 is collected by the shared primary reservoir 2′. The shared primary reservoir 2′ is positioned at an elevation lower than those of the fourth reservoir 12′ and water turbines WT1, WT2.

Initialization of all three hydropower plants H1, H2, H3 is operated sequentially by the system controller 14. The operation of the first hydropower plant H1 is initialized by having its standby water pump pumping water from the shared primary reservoir 2′ into the upper compartment UC of its storage tank. The cycle of the first hydropower plant H1 begins when its diaphragm moves downward from position X to position Y as illustrated in FIG. 4. The cycle continues as illustrated in FIGS. 5 and 6 and then the whole cycle repeats itself again.

Once the first hydropower plant H1 begins operation, the second hydropower plant H2 is initialized by having its standby water pump pumping water supply from the shared primary reservoir 2′ into the upper compartment UC of its storage tank. The cycle of the second hydropower plant H2 begins when its diaphragm moves downward from position X to position Y as illustrated in FIG. 4. The cycle continues as illustrated in FIGS. 5 and 6 and then the whole cycle repeats itself again.

Once the second hydropower plant H2 begins its operation, the third hydropower plant H3 is initialized by having its standby water pump pumping water supply from the shared primary reservoir 2′ into the upper compartment UC of its storage tank. The cycle of the third hydropower plant H3 begins when its diaphragm moves downward from position X to position Y as illustrated in FIG. 4. The cycle continues as illustrated in FIGS. 5 and 6 and then the whole cycle repeats itself again.

If there is a significant increase in demand for electricity, the system controller 14′ increases the flow rate of water in all three hydropower plants H1, H2, H3 to increase the generation of electricity. If there is a significant drop in demand for electricity, the system controller 14′ reduces the flow rate of water in any of the three hydropower plants H1, H2, H3 or temporarily stops the operation of any of the three hydropower plants H1, H2, H3.

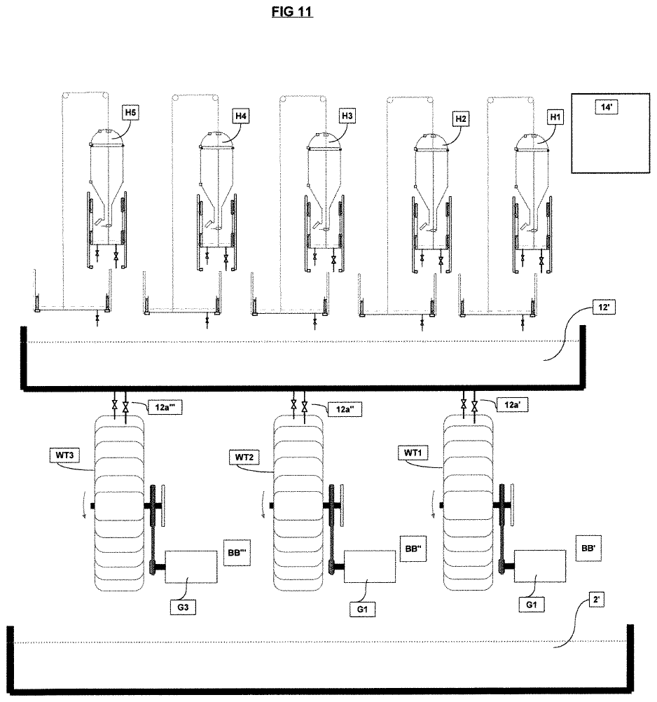

FIG. 11 illustrates another embodiment in which the hydropower plant system integrates five hydropower plants H1, H2, H3, H4, H5. The system having five hydropower plants H1, H2, H3, H4, H5 drives three water turbines WT1, WT2, WT3 with each of the water turbines WT1, WT2, WT3 connected to its respective power generator G1, G2, G3 for generating electricity. The electricity generated by the generators G1, G2, G3 is supplied to the consumer or a power grid. Surplus electricity is stored in a storing means BB such as a battery bank. The stored electricity can be supplied to the consumer or power grid as controlled by a system controller 14′.

The system controller 14′ monitors and controls operations of the five hydropower plants H1, H2, H3, H4, H5. Each of the five hydropower plants H1, H2, H3, H4, H5 comprises all of the components of the hydropower plant 1 as illustrated in FIG. 1, with the exception of a shared primary reservoir 2′, a shared fourth reservoir 12′ and a system controller 14′. With the exception of the shared primary reservoir 2′ and shared fourth reservoir 12′, all of the components of the hydropower plants H1, H2, H3, H4, H5 are identical in its dimensions to the components of the hydropower plant 1 of FIG. 1. The shared primary reservoir 2′ is a rectangular shaped tank with a dimension of 14.0 m length, 10.0 m width and 1.5 m height and has a capacity to store 210.0 m³ of water. The shared fourth reservoir 12′ is a rectangular shaped tank with a dimension of 9.0 m length, 5.0 m width and 1.0 m height and has a capacity to store 45.0 m³ of water.

The five hydropower plants H1, H2, H3, H4, H5, operate independently of each other to produce water to be collected by the shared fourth reservoir 12′. The water in the shared fourth reservoir 12′ is discharged through the opening of the control valves 12a′, 12a″ to drive the water turbines WT1, WT2, WT3. Opening and closing of the control valves 12a′, 12a″, 12a″ is controlled by the system controller 14. The water discharged from the shared fourth reservoir 12′ to rotate the three water turbines WT1, WT2, WT3 is collected by the shared primary reservoir 2′. The shared primary reservoir 2′ is positioned at an elevation lower than that of the fourth reservoir 12′ and water turbines WT1, WT2, WT3.

Initialization of all five hydropower plants H1, H2, H3, H4, H5 is operated sequentially by the system controller 14′. The operation of the first hydropower plant H1 is initialized by having its standby water pump pumping water supply from the shared primary reservoir 2′ into the upper compartment UC of its storage tank. The cycle of the first hydropower plant H1 begins when its diaphragm moves downward from position X to position Y as illustrated in FIG. 4. The cycle continues as illustrated in FIGS. 5 and 6 and then the whole cycle repeats itself again.

Once the first hydropower plant H1 begins operations, the second hydropower plant H2 is initialized by having its standby water pump pumping water supply from the shared primary reservoir 2′ into the upper compartment UC of its storage tank. The cycle of the second hydropower plant H2 begins when its diaphragm moves downward from position X to position Y as illustrated in FIG. 4. The cycle continues as illustrated in FIGS. 5 and 6 and then the whole cycle repeats itself again.

Once the second hydropower plant H2 begins operations, the third hydropower plant H3 is initialized by having its standby water pump pumping water supply from the shared primary reservoir 2′ into the upper compartment UC of its storage tank. The cycle of the third hydropower plant H3 begins when its diaphragm moves downward from position X to position Y as illustrated in FIG. 4. The cycle continues as illustrated in FIGS. 5 and 6 and then the whole cycle repeats itself again.

Once the third hydropower plant H3 begins operations, the fourth hydropower plant H4 is initialized by having its standby water pump pumping water supply from the shared primary reservoir 2′ into the upper compartment UC of its storage tank. The cycle of the fourth hydropower plant H4 begins when its diaphragm moves downward from position X to position Y as illustrated in FIG. 4. The cycle continues as illustrated in FIGS. 5 and 6 and then the whole cycle repeats itself again.

Once the fourth hydropower plant H4 begins operations, the fifth hydropower plant H5 is initialized by having its standby water pump pumping water supply from the shared primary reservoir 2′ into the upper compartment UC of its storage tank. The cycle of the fifth hydropower plant H5 begins when its diaphragm moves downward from position X to position Y as illustrated in FIG. 4. The cycle continues as illustrated in FIGS. 5 and 6 and then the whole cycle repeats itself again.

If there is a significant increase in demand for electricity, the system controller 14′ increases the flow rate of water in all five hydropower plants H1, H2, H3, H4, H5 to increase the generation of electricity. If there is a significant drop in demand for electricity, the system controller 14′ reduces the flow rate of water in any of the five hydropower plants H1, H2, H3, H4, H5 or temporarily stops the operation of any of the five hydropower plants H1, H2, H3, H4, H5.

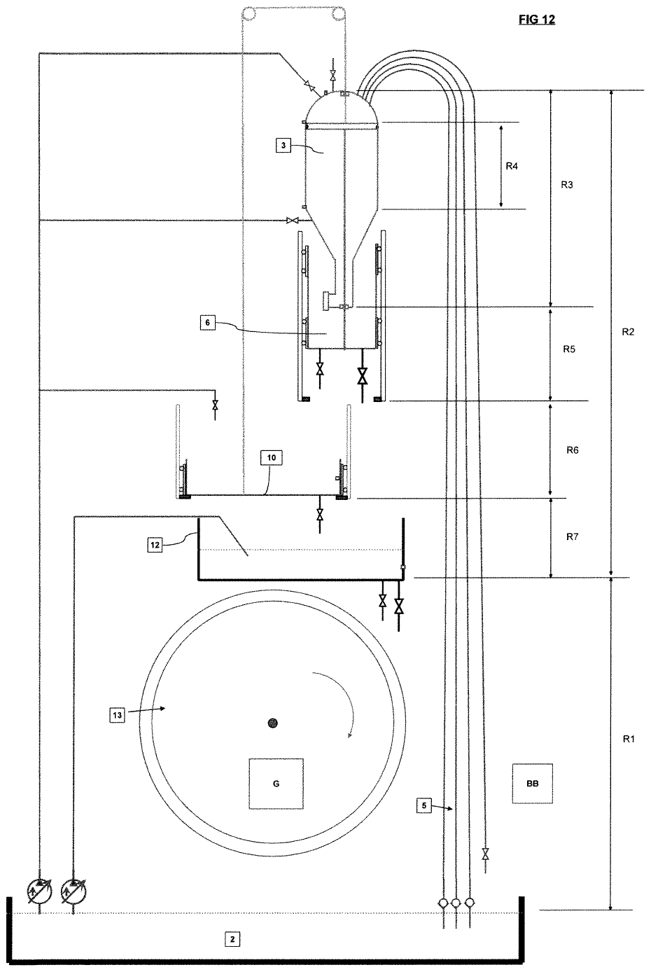

FIG. 12 illustrates an embodiment with an exemplary set-up of a hydropower plant 1 as previously illustrated in FIG. 1. The positioning of the components with respect to each other is important to ensure that the hydropower plant operates at optimal efficiency. The primary reservoir 2 is positioned at the lowest ground level. The fourth reservoir 12 and the water turbine 13 is positioned at an elevation higher than that of the primary reservoir 2. The height, R1 calculated from the base of the fourth reservoir 12 to the top of the water level of the primary reservoir 2 is 6.5 m.

The storage tank 3 is positioned at the highest elevation relative to the rest of the components in the hydropower plant 1. The height, R2, calculated from the oval-shaped top portion 3a of the tank 3 to the base of the fourth reservoir 12 is 5.0 m. The tank 3 has a height, R3 of 1.1 m calculated from the oval-shaped top portion 3a to the base of the tank 3. The diaphragm 4 at position X is positioned at a height, R4 of 0.65 m calculated from the position X in the tank 3 to the top portion of the funnel-shaped base 3c or at the end portion of the elongated body 3b.

The second reservoir 6 is positioned directly below the storage tank 3. The lowest point of the second reservoir 6 with respect to the first and second linear guide rails 7a, 7b is when the base of the second reservoir 6 abuts the two stoppers 7g, 7h at the bottom of the first and second linear guide rails 7a, 7b. The height, R5 calculated from the base of the tank 3 to the lowest point of the second reservoir 6 is 1.4 m.

The third reservoir 10 is positioned below the second reservoir 6, and above the fourth reservoir 12. The lowest point of the third reservoir 10 relative to the first and second guide rails 11a, 11b is when the base of the third reservoir 10 abuts the two stoppers 11e, 11f at the bottom of the first and second guide rails 11a, 11b. The height, R6 calculated from the base of the lowest point of the second reservoir 6 to the lowest point of the third reservoir 10 is 1.2 m.

The fourth reservoir 12 is positioned below the third reservoir 10. The fourth reservoir 12 is positioned in such a way that it is able to receive water discharged from both the second reservoir 6 and the third reservoir 10. The height, R7 calculated from the lowest point of the third reservoir 10 to the base of the fourth reservoir is 1.3 m.

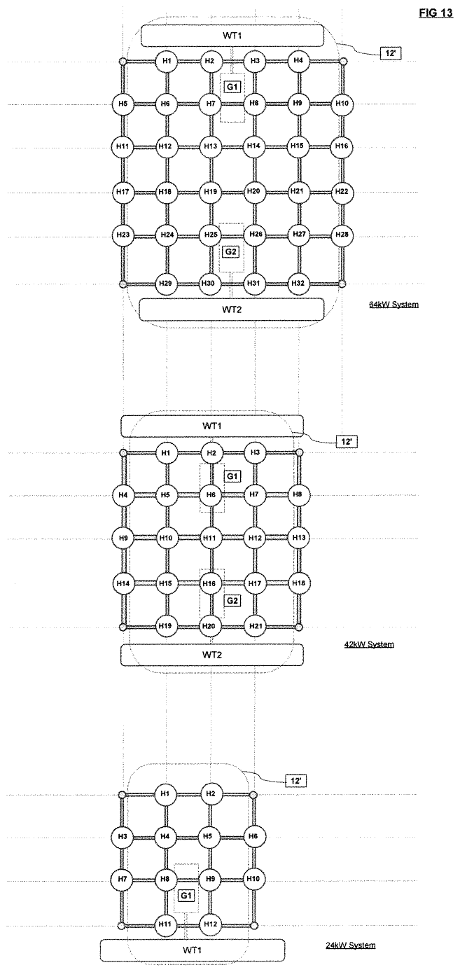

FIG. 13 is a plan view of the different layout of the different embodiments of the hydropower plant systems comprising of a first system of thirty-two hydropower plants for generating 64 kW of electricity, a second system of twenty-two hydropower plants for generating 42 kW of electricity and a third system of twelve hydropower plants for generating 24 kW of electricity.

The self-adaptive hydropower plant system comprises a plurality of hydropower plants in various configurations. The system can be configured to accommodate various scenarios such as those listed below.
1. To supply 2 to 5 KW of power to a terrace house in a city to complement the usage of electricity generated by the main power grid. This can potentially help cut down the usage of electricity provided by the main power grid, which in turn helps to minimize the cost of monthly electricity bills.
2. To supply 10 to 20 KW of power to a cluster of houses with basic electrical appliances.
3. To supply 50 to 100 KW of power to a series of single-storey houses. The hydropower plant system can be cascaded to increase the capacity of electricity generation. By increasing the number of hydropower plants, the system is capable to provide higher volume of water to drive multiple water turbines to produce a higher output of electricity.

The self-adaptive hydropower plant system is scalable to comprise multiple hydropower plants integrated into a network to meet higher demands of electricity for example to supply electricity to a row of houses, or a large office building. As long as there is sufficient space for installation of the multiple hydropower plants, the generation of the electricity is easily scalable to support users' needs for higher demand of electricity.

The self-adaptive hydropower plant system can be set up in a modular configuration for the following power ratings.
2 kw, 5 KW, 10 KW, 50 KW, 100 KW, 200 KW, 500 KW, 1 MW 2×5 KW is 10 KW
4×5 KW is 20 KW
10×5 KW is 50 KW
2×100 KW is 200 KW

In an embodiment, the self-adaptive hydropower plant can also be used for propulsion of a marine vessel. The torque generated by the water turbine of the hydropower plant can be converted to propel the marine vessel without fuel. This application can save fuel cost for the marine and shipping industry and directly reduce carbon emission.

In another embodiment, the self-adaptive hydropower plant can be installed at expressways to provide electricity to EV charges. The common practice of setting up pylons and laying copper wires within a few hundred kilometers to supply a small amount of electricity for EV charges is not cost-effective or economical. Although the EV charger can be powered by solar panels but that is limited to daylight hours. The hydropower plant seeks to resolve this limitation as its generation of electricity is not limited by climate or weather.

In a further embodiment, the self-adaptive hydropower plant is configured to operate based on a supply and demand configuration. A plurality of sensors is provided at various points of facilities that require electricity, with each sensor connected to the system controller. Upon detecting a demand of electricity in any of the facilities, the system controller triggers the generation of electricity by increasing the water flow rate in the hydropower plant. Every configuration is designed with a range of capacity of power electrification. The design of the hydropower plant is a closed loop system. The feedback sensors synchronize between the load/user and the water flow rate from the third reservoir. The storage tank with the diaphragm operates independently.

According to an embodiment, the self-adaptive hydropower plant can be utilized in such a way to work as a big water pump to lift water up from a lower elevation by relying on vacuum suction energy.

According to another embodiment, the self-adaptive hydropower plant can be utilized to enhance the capacity of an existing micro hydro plant by generating an additional supply of electricity.

This invention may also be embodied in many ways other than those specifically described herein, without departing from the scope thereof.

1. A self-adaptive hydropower plant (1) that enables a continuously circulating volume of water within a closed loop flow path for generating electricity, said plant comprising:
a primary reservoir (2) for storing and providing a supply of water;
a storage tank (3) elevated above said primary reservoir for receiving water from said primary reservoir and facilitating a flow of water from said tank to said primary reservoir;
a diaphragm (4) within said storage tank for defining upper and lower chambers of the storage tank, the diaphragm being vertically moveable within said tank;
a plurality of secondary reservoirs (6, 10, 12) comprising a second reservoir (6), a third reservoir (10) and a fourth reservoir (12), located at an elevation below said storage tank but above said primary reservoir;
at least one turbine (13) positioned below said secondary reservoirs but above said primary reservoir for generating electricity from water distributed from said secondary reservoirs to said primary reservoir; and
a system controller (14) for controlling and monitoring the flow of water from said primary reservoir to said storage tank and secondary reservoirs;
wherein movement of the diaphragm within the storage tank facilitates the distribution of water from the tank into the secondary reservoirs;
the secondary reservoirs being adapted to facilitate the distribution of water to the turbine and the movement of the diaphragm within the storage tank being in synchrony with the secondary reservoirs to initiate replenishment of water in the tank by the primary reservoir;
wherein the second reservoir is located at an elevation lower than and receiving water from said storage tank and is moveable upward and downward in sync with the movement of the diaphragm within said storage tank,
wherein the third reservoir is located at an elevation lower than and receiving water from the second reservoir, movable upward and downward in opposite direction to the movement of the diaphragm and second reservoir, and
wherein the fourth reservoir is located at an elevation lower than and receiving water from the second and third reservoirs, and subsequently discharging water onto said turbine, which is located at an elevation lower than the fourth reservoir; and
the water from said turbine is collected by the primary reservoir located at an elevation lower than the fourth reservoir and the turbine;
wherein the water in the primary reservoir is selectively distributed to the storage tank and the secondary reservoirs to reduce water loss.

2. (canceled)

3. The hydropower plant (1) according to claim 1, wherein said storage tank (3) further comprises a connecting rod (8), a first end of the rod connected to the lower portion (4b) of said diaphragm (4) and a second end extending downward and protruding through a base (3c) of the storage tank and fixed to a base of the second reservoir (6).

4. The hydropower plant (1) according to claim 1, wherein said plant further comprises a pulley mechanism (9) to synchronize the movement of the diaphragm (4) and second reservoir (6) and third reservoir (10) during distribution of water within the secondary reservoirs such that, when the diaphragm and second reservoir move downward, the third reservoir moves upward and when the third reservoir moves downward, the diaphragm and second reservoir move upward.

5. The hydropower plant (1) according to claim 1, wherein said plant further comprises a linear guide assembly provided to the second and third reservoirs (6; 10), said assembly comprising:
at least two guide rails (7a, 7b; 11a, 11b) positioned on opposing sides of each of the second and third reservoirs,
a plurality of linear guides and bearings (7c, 7d, 7e, 7f; 11c, 11d) being moveably supported on said guide rails; and
at least two stoppers (7g, 7g; 11e, 11f) positioned at the end of said guide rails for limiting the movement of the second and third reservoirs once the base of both the second and third reservoirs abut said stoppers.

6. The hydropower plant (1) according to claim 1, wherein when the supply of water is discharged from the storage tank (3) into the second reservoir (6), the diaphragm (4) moves downward in synchrony with the downward movement of the second reservoir such that a vacuum is created in the upper chamber (UC) of the tank which triggers a supply of water to be delivered from the primary reservoir (2) to replenish the water in the tank; and
when the supply of water is discharged from the second reservoir to the third and fourth reservoirs (10; 12), the flow of water into the third reservoir causes the third reservoir to move downward, which causes the diaphragm to move upward together with the second reservoir.

7. The hydropower plant (1) according to claim 1, wherein said storage tank (3) further comprises first and second position-detecting sensors (3e, 3f) for detecting the position of the diaphragm (4) within the tank.

8. The hydropower plant (1) according to claim 1, wherein said plant further comprises a plurality of suction pipes (5) for delivering a supply of water from the primary reservoir (2) to the storage tank (3).

9. The hydropower plant (1) according to claim 8, wherein each of said suction pipes (5) is provided with a check valve (5a) operable to prevent the water delivered to the storage tank (3) from flowing back to the primary reservoir (2).

10. The hydropower plant (1) according to claim 1, wherein said plant further comprises a plurality of control valves (3dx; 6a, 6b) provided in each of said storage tank (3) and said secondary reservoirs (6), said valves operable by said system controller to facilitate the distribution of water from said tank and secondary reservoirs.

11. The hydropower plant (1) according to claim 1, wherein said plant further comprises a plurality of sensors (3g, 10b, 12b) provided in each of said storage tank (3) and said secondary reservoirs (6, 10, 12), for monitoring the water supply in said tank and said reservoirs.

12. The hydropower plant (1) according to claim 1, wherein said storage tank (3) comprises an enclosed cylindrical tank with an oval-shaped top portion (3a), an elongated body (3b), a funnel-shaped base (3c) and an outlet gate (3d) disposed at the bottom portion of the funnel-shaped base.

13. The hydropower plant (1) according to claim 12, wherein said storage tank (3) further comprises a plurality of bearings and seals (B1, B2) provided at said top portion (3a) and said base (3b) to seal the area between said pulley mechanism (9) connected to said diaphragm (4) and said top portion and the area between said connecting rod (8) and the bottom portion of said base.

14. The hydropower plant (1) according to claim 1, wherein said diaphragm (4) comprises:
at least two openings (Ox, Oy) for allowing water to flow therethrough, and at least two flippers (4x, 4y) fixedly hinged to the center (C) of said diaphragm for opening and closing said openings;
wherein when said diaphragm moves downward, said flippers are closed to prevent water from flowing from the lower chamber (LC) of said storage tank (3) into the upper chamber (UC), and when said diaphragm moves upward, said flippers are opened to facilitate movement of water from the upper chamber of said storage tank into the lower chamber.

15. The hydropower plant (1) according to claim 1, wherein said plant further comprises a vent pipe (T) connected to said storage tank (3) for facilitating the release of air from the upper compartment (UC) of said tank.

16. The hydropower plant (1) according to claim 15, wherein said vent pipe (T) is provided with a release valve and a sensor operable by said system controller (14).

17. The hydropower plant according (1) to claim 1, wherein said plant further comprises at least one power generator (G) mechanically connected to said turbine (13).

18. The hydropower plant (1) according to claim 17, wherein surplus electricity generated by the power generator (G) is stored in a storing means (BB).

19. The hydropower plant (X1) according to claim 1, wherein said plant further comprises an alternative source of water for supply to said secondary reservoirs (6, 10, 12).

20. The hydropower plant (X1) according to claim 19, wherein said alternative source of water is positioned at an elevation above said secondary reservoirs (6, 10, 12).

21. The hydropower plant (1) according to claim 1, wherein said plant further comprises a plurality of pumping means (P1, P2) operable by said system controller (14) for pumping a supply of water from said primary reservoir (2) to said storage tank (3) and said secondary reservoirs (6, 10, 12).

22. The hydropower plant (1) according to claim 21, wherein said pumping means (P1, P2) is operable to initialize the closed loop flow path by pumping a supply of water from said primary reservoir (2) into said storage tank (3) and fourth reservoir (12).

23. The hydropower plant (1) according to claim 21, wherein said pumping means (P1, P2) is operable to replenish water in said storage tank (3) and/or third reservoir (10), by initiating water flow from said primary reservoir (2), when the sensors in said tank and said reservoir detects that the water level in said tank and reservoir is less than the predetermined minimum level of water.

24. The hydropower plant (1) according to claim 21, wherein said pumping means (P1, P2) is operable to replenish water in said fourth reservoir (12), by initiating water flow from said primary reservoir (2), when the sensors (12b) in said reservoir detects that the water level in said reservoir is less than the predetermined minimum level of water.

25. The hydropower plant (1) according to claim 22, wherein said pumping means (P1, P2) comprises a plurality of water pumps.

26. A self-adaptive hydropower plant system, said system comprising more than one hydropower plant (H1, H2, H3, H4, H5) according to claim 1, said plants integrated into a network of plants for generating electricity.

27. The system according to claim 26, wherein said hydropower plants (H1, H2, H3, H4, H5) operate independently of each other to facilitate continuous recirculation of a controlled volume of water within a closed loop flow path for rotating at least one turbine (WT1, WT2, WT3) to generate electricity.

28. The system according to claim 26, wherein said hydropower plants (H1, H2, H3, H4, H5) shares a primary reservoir (2′) and a fourth reservoir (12′).

29. The system according to claim 28, wherein said shared primary reservoir (2′) supplies water to each of said storage tanks of said hydropower plants (H1, H2, H3, H4, H5).

30. The system according to claim 28, wherein said shared fourth reservoir (12′) collects water from each of the second reservoirs and third reservoirs of said hydropower plants (H1, H2, H3, H4, H5).

31. The system according to claim 28, wherein said shared fourth reservoir (12′) releases water to said shared primary reservoir (2′) to drive at least one turbine (WT1, WT2, WT3) for generating electricity.

32. The hydropower plant (X1) according to claim 19, wherein said alternative source of water is a supplementary water source for said primary reservoir (2) and is positioned between said fourth reservoir (12) and said primary reservoir.

33. The hydropower plant (X1) according to claim 19, wherein said alternative source of water is a supplementary water source for said primary reservoir (2) and/or said third reservoir (10).

34. The hydropower plant (1) according to claim 1, wherein said primary reservoir (2) comprises a municipal water reservoir.

35. The hydropower plant (1) according to claim 1, wherein said plant further comprises at least one additional reservoir connected to said fourth reservoir (12).
